(19) United States
(12) Patent Application Publication
(10) Pub. No.: US 2021/0063669 A1
(43) Pub. Date: Mar. 4, 2021

(54) SUBMERSIBLE PASSIVE OPTICAL MODULE AND SYSTEM

(71) Applicant: Champion Optical Network Engineering, LLC, Independence, OH (US)

(72) Inventor: LARRY RAYMOND LEGG, INDEPENDENCE, OH (US)

(21) Appl. No.: 17/003,712

(22) Filed: Aug. 26, 2020

Related U.S. Application Data
(60) Provisional application No. 62/893,919, filed on Aug. 30, 2019.

(51) Int. Cl. G02B 6/50; G02B 6/44

(52) U.S. Cl. CPC G02B 6/506; G02B 6/4454

(57) ABSTRACT

A submersible optical module and system to contain and protect fiber optic cables within a splice tray. Access holes on the module allow for an entry point and exit point of the optical fibers. Once set up with the module cavity containing the desired fiber optic cables, the remaining void space of the module cavity is filled with an epoxy creating a protective seal and barrier to provide superior protection to fiber optic cables from moisture.

### RELATED APPLICATIONS

This application claims the benefit of U.S. provisional patent application Ser. No. 62/893,919 ('919) and its filing date Aug. 30, 2019. The present invention incorporates all of the subject matter disclosed in '919 as if it were fully rewritten herein.

### BACKGROUND OF THE INVENTION

### Field of the Invention

The present invention relates to a submersible passive optical module and system that better protects the enclosed fiber optic cables.

### Description of the Related Art

Fiber optic cables are used in many areas. An area where they are widely used is in fiber optic communications. In today's business world, many of the tools used to enhance business performance rely on data transmission, including but not limited to, video or web conferencing, streaming video, file sharing, various cloud applications, and many other productivity applications. Fiber optic systems can provide an upper hand because optical fibers have significant advantages over electrical cabling alternatives, such as copper cables.

Fiber optic cables have a core that carries light to transmit data. This allows fiber optic cables to carry signals at speeds significantly faster than copper cables. Additionally, fiber optic cables have less signal degradation than their copper counterparts. Even when high demands are put on the network, the speed at which data is transmitted is not decreased.

Optical fibers also allow for higher bandwidth transmission than traditional cables of the same diameter. Low bandwidth can lead to slower speeds, delays, pixelated video quality, and other disruptions that ultimately impede the users of the system.

Fiber optic cables can carry signals over greater distances without losing strength or relying on signal boosters. With copper cables, the signal degrades the farther a user is from source with a limitation of a few hundred feet; however, fiber optic cables can carry a signal much further, depending on the type of fiber cable, wavelength and network, before the signal degrades.

Fiber optic cable is also less vulnerable to interference. Copper cables are sensitive to electromagnetic fields, such as those caused by the proximity of heavy machinery, utility lines, power lines, or railroad tracks. While a copper network cable requires shielding to protect it from electromagnetic interference, still it is not sufficient to prevent interference when many cables are strung together in proximity to one another. Fiber optic cables are not affected by electromagnetic interference; therefore, the signals do not degrade or disappear due to the presence of electromagnetic interference.

Fiber optic cables are also thinner and lighter than traditional copper cables. Additionally, they can withstand more pull pressure and are less prone to damage or breakage. However, they are still susceptible to damage that can impair the strength of the fiber and in return its ability to perform. The fiber's strength can be particularly degraded in outdoor environments where it is subject to environmental hazards, principally water. Any surface flaws in the fiber can be exacerbated causing flaw growth through dynamic fatigue, static fatigues, and zero-stress aging. Damaged fiber optic cables can lead to signal distortion and an interminable list of other faults. A critical concern in outdoor cabling is to protect the fiber from contamination or damage by water to reduce the occurrence of flaw growth and maintaining the strength of the fiber. Therefore, there exists a need for an improved system both to secure and to better protect fiber optic cables in harsh environments where it is exposed to water and moisture.

### SUMMARY OF THE INVENTION

These and other objects are achieved by the instant invention. The present invention is a submersible passive optical module and system that protects the contained fiber optic cables from harsh environmental factors.

Briefly described according to a preferred embodiment of the present invention, a module contains fiber optic cables within a splice tray. Access holes are present on the module that allow for an entry point and exit point of the optical fibers. Once set up with the module cavity containing the desired fiber optic cables, the remaining void space of the module cavity is filled with an epoxy. This creates a protective seal and barrier to provide superior protection to fiber optic cables from moisture.

A more detailed description of the present invention is set forth in the following description. Other advantages and novel features of the present invention are more apparent in the following detailed description of the invention when considered in conjunction with the accompanying drawings.

### BRIEF DESCRIPTION OF THE DRAWINGS

FIG. 1 is a top view of the submersible passive optical module;

FIG. 2 is a top view of the submersible passive optical module with the module top removed;

FIG. 3 is a right-side view of the submersible passive optical module showing the holes that permit the fibers to pass through;

FIG. 4 is a perspective view of the submersible passive optical module;

FIG. 5 is a perspective view of the submersible passive optical module with the module top removed;

FIG. 6 is a perspective view showing the module top removed and held near the module base of the submersible passive optical module;

FIG. 7 is a perspective view of the module top;

FIG. 8 is a right-side perspective view of the submersible passive optical module including the holes that permit the fibers to pass through;

FIG. 9 is a side perspective view of the submersible passive optical module including the holes that permit the fibers to pass through with the top removed;

FIG. 10 is a top view of the submersible passive optical module including a partial view of the fibers;

FIG. 11 is a top view of the submersible passive optical module including the fibers;

FIG. 12 is a top view of the submersible passive optical module in an exemplary splice tray configuration; and

FIG. 13 is a top view of the submersible passive optical module in an alternate exemplary splice tray configuration.

### DESCRIPTION OF THE PREFERRED EMBODIMENTS

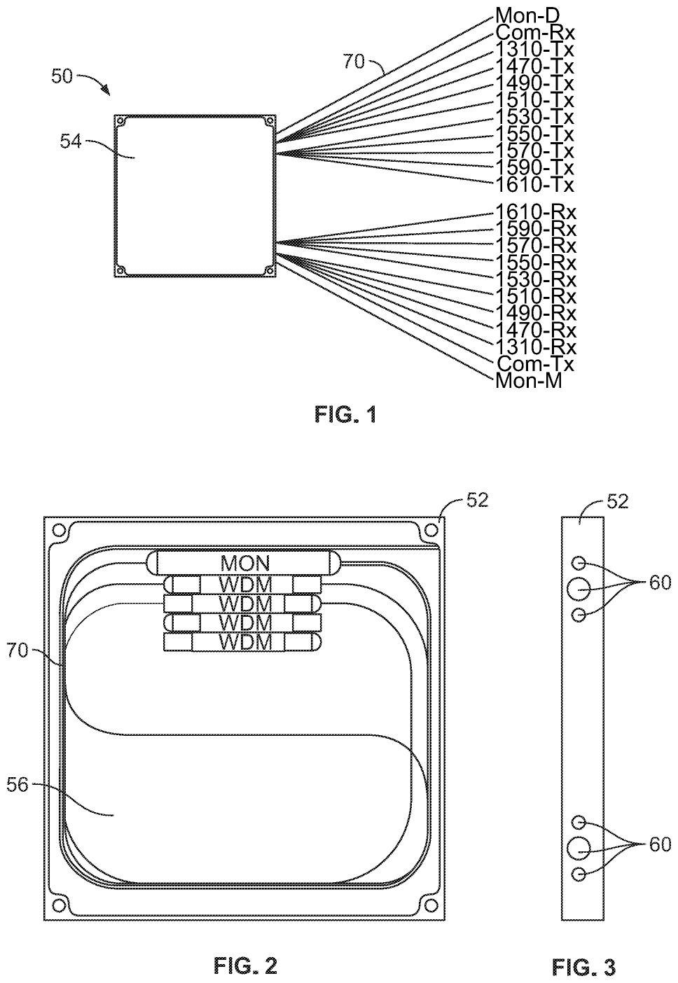

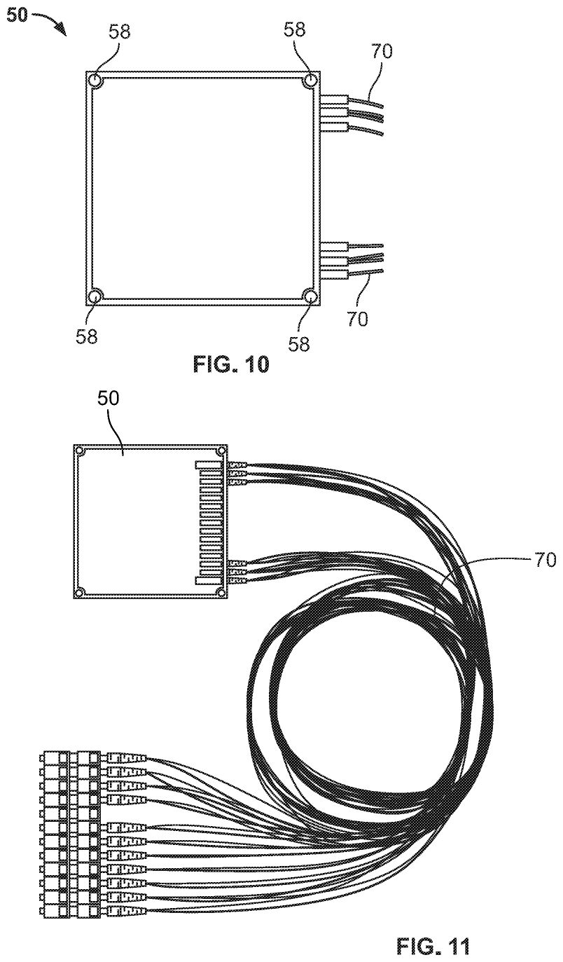

The best mode for carrying out the invention is presented in terms of its preferred embodiment, herein depicted within FIGS. 1 through 13.

### DETAILED DESCRIPTION OF THE FIGURES

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Referring now to the figures, FIG. 1 depicts a top view of the submersible passive optical module 50 with the module top 54 in place and the optical fibers 70 entering and exiting the module on the side. A top view of the module 50 is shown in FIG. 2 without the module top 54, showing the optical fibers 70 within the module cavity 56. FIG. 3 shows the side view of the module 50 with the access points 60 that allow the optical fibers 70 to enter and exit the module 50. FIG. 3 shows six access points 60, but one skilled in the art would know that any desired number of access points could be used depending on the desired optical fiber configuration.

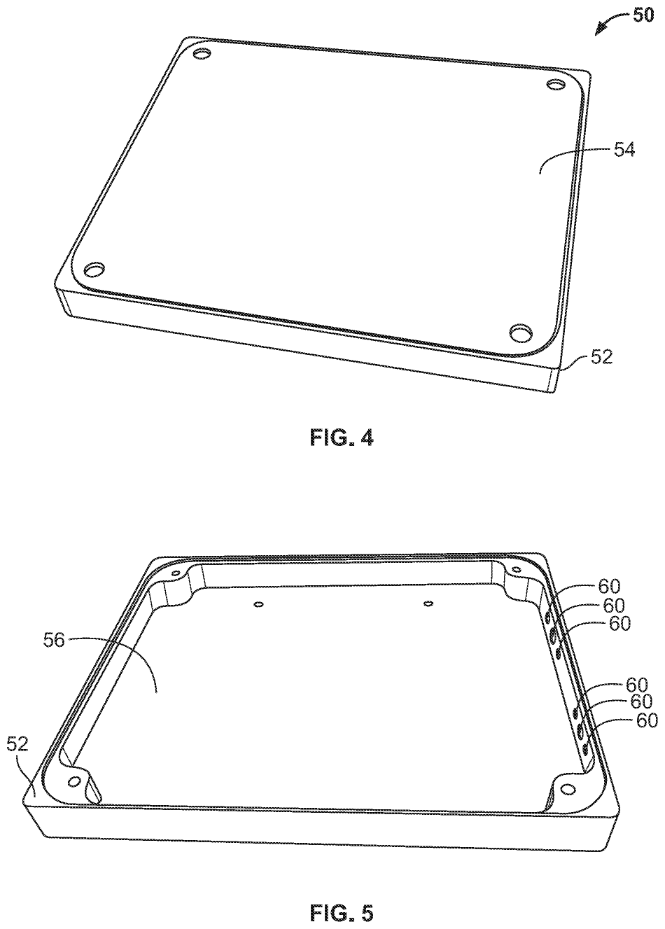

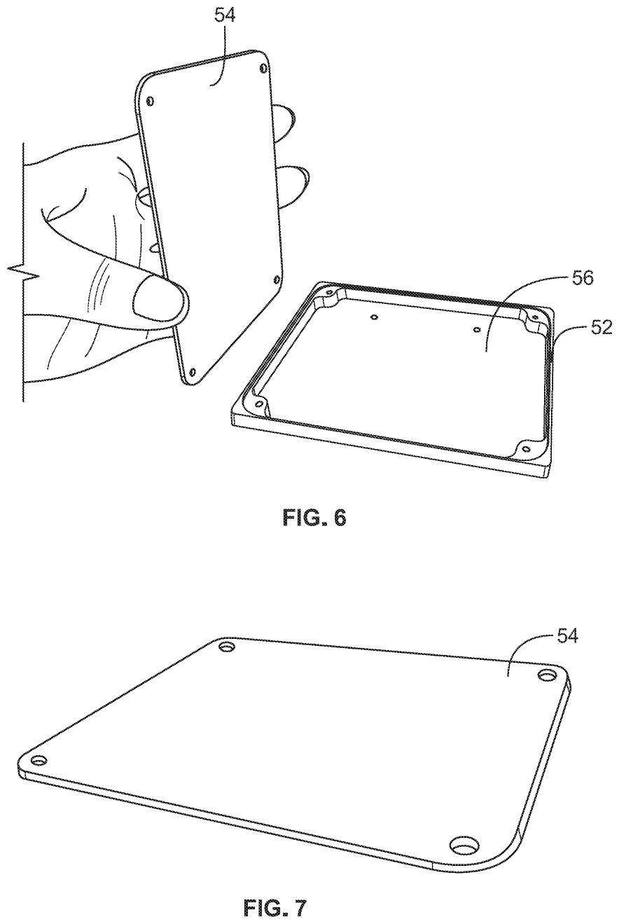

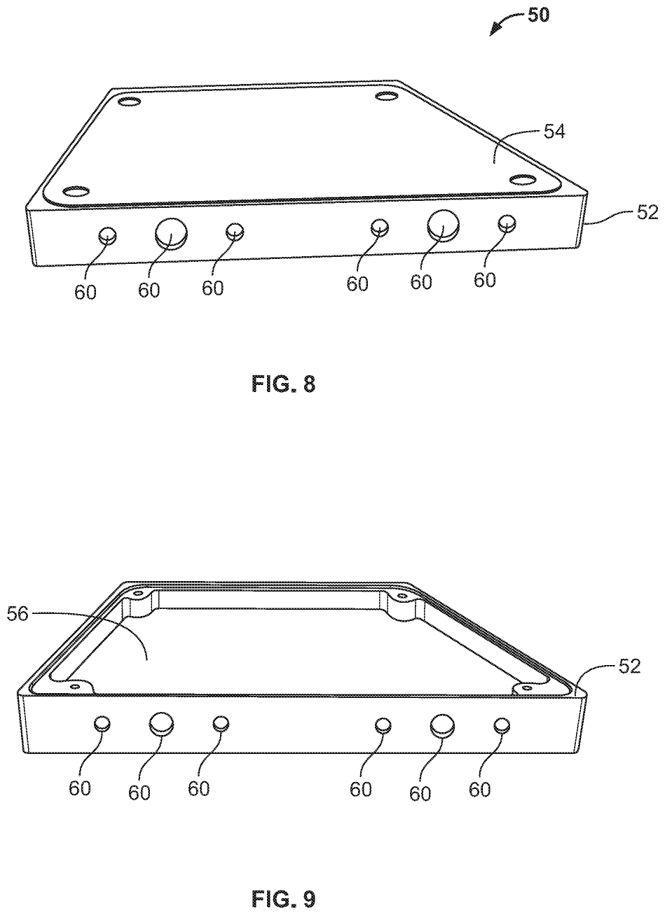

FIG. 4 again shows the module 50 with the module top 54 in place. FIG. 5 shows the module base 52 alone, without the optical fibers 70 or module top 54. FIG. 6 shows the module top 54 lifted off the module base 52. FIG. 7 shows the module top 54 alone. FIG. 8 shows a side view of the module 50 where the access points 60 for the optical fibers are located. FIG. 9 shows the side view of the module base 52 where the access points 60 for the optical fibers are located. FIGS. 8 and 9 depict an alternate embodiment with four access points 60. As noted above, one skilled in the art would know any plurality of access points necessary for the desired configuration could be used.

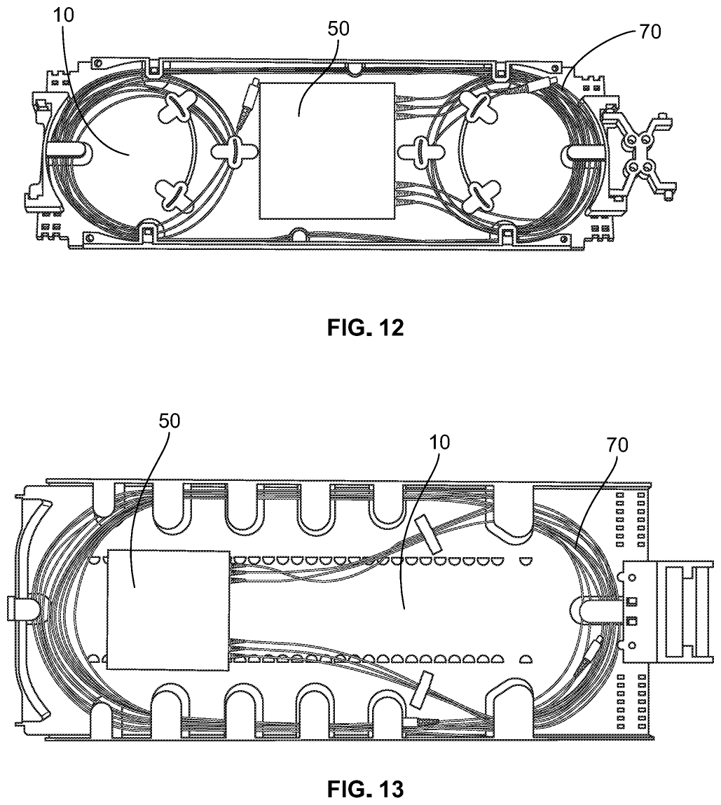

When fiber optic cables are employed, it is often necessary to merge individual fibers into a single fiber. Splice trays are designed to safely route and store optical fiber and associated splices. FIGS. 12 and 13 show example splice trays 10 containing the module 50 in varying configurations. One skilled in the art would know the module could be employed in any multitude of splice tray configurations.

Once the optical fibers are arranged in the desired position within the module cavity 56 and the module top 54 is affixed to the module base 52, the module cavity 56 is filled with an epoxy material. This creates a protective seal around the optical fibers that can withstand exposure to water and moist environments. Testing of this system after six months with the module under one meter of water resulted in no change to the characteristics of the optical fibers.

As used herein, it is intended that the terms “fiber optic cables” and “optical fibers” include all types of single-mode and multi-mode fibers. Furthermore, to the extent that the term “includes” is used in either the detailed description or the claims, such term is intended to be inclusive in a manner similar to the term “comprising” as “comprising” is interpreted when employed as a transitional word in a claim.

The foregoing descriptions of specific embodiments of the present invention are presented for purposes of illustration and description. They are not intended to be exhaustive or to limit the invention to precise forms disclosed and, obviously, many modifications and variations are possible in light of the above teaching. The embodiments were chosen and described in order to best explain principles of the invention and its practical application, to thereby enable others skilled in the art to best utilize the invention and its various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. A submersible passive optical module system comprising:
a module base;
a module top;
an epoxy; and
a plurality of optical fibers;
wherein said module base is capable of holding the optical fibers and the epoxy when the module top is fixedly attached to the base.

2. A submersible passive optical module system comprising:
a module base;
a module top;
an epoxy;
a plurality of optical fibers; and
a splice tray;
wherein said module base is capable of holding the optical fibers and the epoxy when the module top is fixedly attached to the base.

3. A method of constructing a submersible passive optical module system comprising:
constructing a module base of sufficient size wherein said module base has a cavity capable of housing a desired amount of optical fibers;
constructing a module top wherein said module top is capable of fitting on the module base and creating a closed seal;
placing the optical fibers in the module base in a desired configuration;
placing the module top on the module base; and
filling the cavity in the module base with an epoxy material wherein the module top and the module base together filled with the epoxy material form a submersible module.

4. A method of constructing a submersible passive optical module system comprising:
constructing a module base of sufficient size wherein said module base has a cavity capable of housing a desired amount of optical fibers;
constructing a module top wherein said module top is capable of fitting on the module base and creating a closed seal;
placing the optical fibers in the module base in a desired configuration;
placing the module top on the module base;
filling the cavity in the module base with an epoxy material wherein the module top and the module base together filled with the epoxy material form a submersible module; and
placing the submersible module in a splice tray.
